(19) United States
(12) Patent Application Publication
(10) Pub. No.: US 2009/0317151 A1
(43) Pub. Date: Dec. 24, 2009

(54) Feeding and fixing apparatus for feeding and fixing a functional element to a sheet of film

(75) Inventor: Tiziano Colla, Dino (CH)

Correspondence Address: THE WEBB LAW FIRM, P.C., 700 KOPPERS BUILDING, 436 SEVENTH AVENUE, PITTSBURGH, PA, 15219, US

(73) Assignee: WATER-LINE SA, Mezzovico (CH)

(21) Appl. No.: 12/489,777

(22) Filed: Jun. 23, 2009

(30) Foreign Application Priority Data
Jun. 24, 2008 (CH) 00962/08

(51) Int. Cl. G03G 15/20

(52) U.S. Cl. 399/322

(57) ABSTRACT

A feeding and fixing apparatus for feeding and fixing a functional element, such as a closure element, to a sheet of film includes a feed unit for holding a functional element. The feed unit includes at least one holding device for holding the functional element, the at least one holding device being arranged substantially parallel to the sheet of film and, with a pivoting movement, being capable of being positioned in the region of the sheet of film in a plane running parallel to the sheet of film.

### TECHNICAL FIELD OF THE INVENTION

The present invention relates to a feeding and fixing apparatus for feeding and fixing a functional element to a sheet of film according to the features of the precharacterizing clause of claim 1.

### PRIOR ART

Feeding apparatuses and fixing apparatuses for feeding and fixing a functional element, such as a closure element, to a sheet of film are known from the prior art. The sheet of film is used to produce a bag pack, such as a folding bag, a stand-up bag, etc. In this case, the closure element is used to close an opening through which the product in the bag can be removed.

Such apparatuses are known from the prior art. For instance, WO99/03672 shows an apparatus for fitting a closure element to a bag. In this case, the apparatus comprises a roll having a plurality of holding devices for holding a closure element. The roll is placed under and transversely with respect to the sheet of film and feeds a closure element to the sheet of film by means of a rotary movement.

The disadvantage in the case of apparatuses of the prior art is the fact that the sheet of film with the closure elements already fixed thereto can be processed further only with difficulty. In particular, it is difficult to carry out appropriate folding operations with the sheet of film.

### SUMMARY OF THE INVENTION

Starting from this prior art, the invention is based on the object of specifying an apparatus mentioned at the beginning which overcomes the disadvantages of the prior art. In particular, an apparatus is to be specified which permits a functional element to be fixed to an already folded sheet of film.

This object is achieved by a feeding and fixing apparatus having the features of patent claim 1. Accordingly, a feeding and fixing apparatus for feeding and fixing a functional element to a sheet of film comprises a feed unit for holding a functional element. The feed unit comprises at least one holding device for holding the functional element, the at least one holding device being arranged substantially parallel to the sheet of film and, by means of a pivoting movement, being capable of being positioned in the region of the sheet of film in a plane running parallel to the sheet of film.

As a result of the pivoting movement of the feed unit and the holding device, the attachment of a functional element in the sheet of film is made possible. In this case, the holding device with the functional element is moved from a location outside the sheet of film to a location inside the sheet of film via a pivoting movement.

The feed unit preferably also comprises a feed plate, the at least one holding device being connected to the feed plate, and the surface of the feed plate being substantially parallel to the sheet of film. The feed plate preferably has the shape of a circular disc and, for example, can be built up from a number of parts. Alternatively, it is also possible for the feed plate to be constructed as a circular segment. The feed plate is preferably arranged in such a way that parts of it are located in the region of the sheet of film before, during and after the pivoting operation.

The feed plate or the holding device can preferably be pivoted about an axle which is substantially perpendicular to the sheet of film.

The sheet of film is preferably a folded sheet of film, this being folded in such a way that the feed plate or the at least one holding device can extend or project into the folded sheet of film.

At the time at which the functional element is joined to the sheet of film, the holding device is preferably either at right angles to the transport direction or at an angle to the transport direction.

The functional element is preferably a closure element, a re-closable closure element, a guarantee element, a viewing window or a reinforcing element.

Preferably, the apparatus further comprises a Joining unit for joining the functional element to the sheet of film.

The holding device preferably comprises at least one vacuum nozzle which provides a vacuum, so that the functional element is held on the holding device. The vacuum nozzle can be formed in different ways. Use is preferably made of an elongated vacuum nozzle or a plurality of individual vacuum nozzles which are arranged at a distance from one another.

The holding device further comprises at least one section which provides an increased frictional force between functional element and holding device, the section being made of a plastic chosen from the group of elastomers, such as silicone. This section preferably surrounds the vacuum nozzles. Therefore, the functional element can be held by the vacuum nozzles in its central region and rests with the other regions on the plastic.

Preferably, at least two holding devices are arranged at a distance from each other, the angle between adjacent holding devices being equal, and it being possible for a holding device to be loaded with a functional element, and it being possible for the functional element from another holding device to be joined to the sheet of film at the same time.

In a method for feeding and fixing a functional element to a sheet of film, using an apparatus which comprises a feed unit for holding a functional element and a joining unit which produces a connection between the sheet of film and the functional element, by means of a pivoting movement, the functional element is positioned in the region of the sheet of film in a plane running parallel to the sheet of film and, after the pivoting movement, the functional element is joined to the sheet of film.

Further advantageous embodiments are characterized in the subclaims.

### BRIEF DESCRIPTION OF THE DRAWING

Preferred embodiments will be described in more detail by way of example below by using the drawing, in which:

FIG. 1 shows a schematic plan view from above of a feeding and fixing apparatus according to the present invention;

FIG. 2 shows a side view of the feeding and fixing apparatus according to FIG. 1 in the direction of the sheet of film;

FIGS. 3a, b show a detail view from FIG. 1;

FIG. 4 shows a perspective view of a feeding and fixing apparatus according to the present invention; and

FIG. 5 shows a detail view from FIG. 3.

### DESCRIPTION OF PREFERRED EXEMPLARY EMBODIMENTS

With reference to the drawings, possible exemplary embodiments will be described. The drawings and the description show preferred exemplary embodiments and are not intended to be interpreted to restrict the invention, which is defined by the claims.

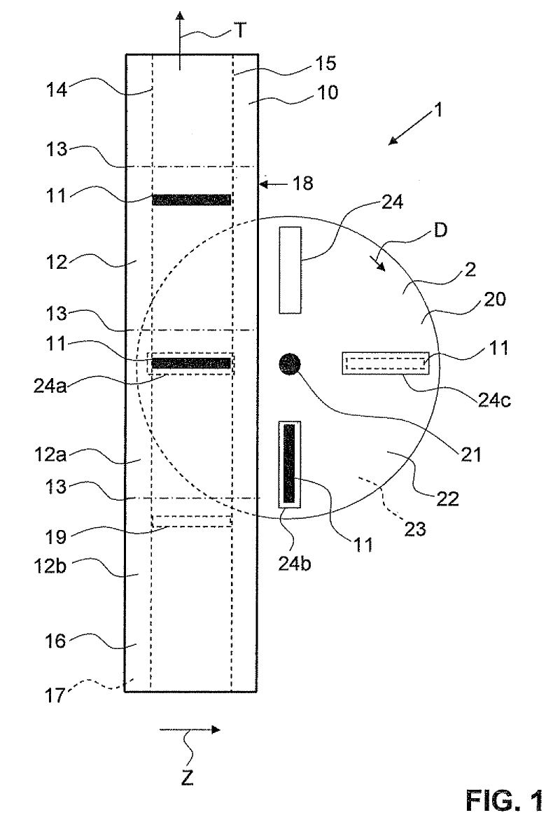

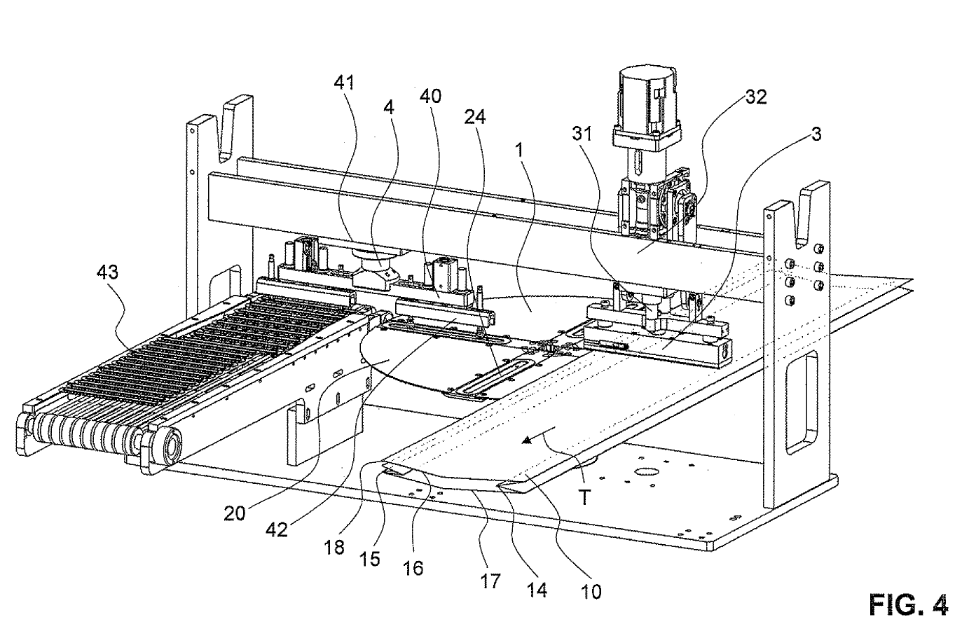

FIG. 1 shows a schematic plan view of a feeding and fixing apparatus according to the invention, and FIG. 4 shows a perspective view of the apparatus according to the invention. The feeding and fixing apparatus 1, which is designated the apparatus 1 below, is used to feed and subsequently fix a functional element 11, which is designated the closure element 11 below, to a sheet of film 10. The apparatus according to the invention can in this case be provided as a station in an apparatus for producing a bag pack, in particular a folding bag. These stations are usually arranged one after another, the sheet of film 10 passing through all these stations. A station which pre-folds the sheet of film is preferably provided before the apparatus according to the invention.

A functional element 11 is generally understood to mean an additional element which is to be joined to the sheet of film 10. In particular, a functional element 11 is understood to mean a closure element, a re-closable closure element, a guarantee element, a viewing window or a reinforcing element. The expression closure element used below includes the elements just mentioned. A closure element 11 is understood, for example, to mean a zip fastener or a similar element. The closure element 11 is in this case designed to be re-closable and can include a guarantee element which is destroyed at the time of first opening.

A pre-folded sheet of film 10 is to be understood to mean a continuous film for the production of a bag. The pre-folded sheet of film comprises a left-hand side fold 14, a right-hand side fold 15, an upper side 16 of the sheet of film and an underside 17 of the sheet of film. Seen in cross section, the upper side 16 of the sheet of film and the underside 17 of the sheet of film lie substantially parallel to each other and are joined either by the left-hand side fold 14 or by the right-hand side fold 15, so that at least one interspace 18 is produced, through which parts of the apparatus can project. The left-hand side fold 14 and the right-hand side fold 15 can be c-shaped, v-shaped in cross section or bellows-like with a plurality of folds. Other forms are also conceivable. In this case, the sheet of film 10 is subdivided in the direction of the transport direction T into a plurality of sections 12. Each of these sections 12 represents a bag to be produced. In each case, a closure element 11 is provided for each section 12. In a following item of equipment, the strip of film can then be cut along the cut lines 13 in order to finish the bag.

The feeding and fixing apparatus 1 according to the invention substantially comprises a feed unit 2 for holding a closure element 11 and an optional joining unit 3, which produces a connection between the sheet of film 10 and the closure element 11. Furthermore, the apparatus 1 can optionally comprise a loading apparatus 4, which loads the feed unit 2 with the closure elements 11. The elements described in this section will be described below.

The feed unit 2 substantially comprises a feed plate 20 and at least one holding device 24 connected to this feed plate 20. The holding device 24 is used to accommodate and to hold the closure element 11 during the feeding operation and the joining operation. The feed unit 2 or the feed plate 20 and the sheet of film 10 are located in relation to one another in such a way that the sheet of film 10 runs substantially parallel to the feed plate 20.

In the present exemplary embodiment, the feed plate 20 is formed as a disc having a circular basic shape. Here, a disc is understood to mean a cylindrical body having a diameter which is many times greater than the height of the body. It is important that the feed plate 20 has the lowest possible height or thickness, so that it is able to project into the pre-folded sheet of film 10. The thickness is preferably between 10 mm and 50 mm. The disc or the feed plate 20 is bounded at the top and bottom by an upper side 22 and an underside 23. The feed plate can be pivoted or rotated about a shaft 21, which is joined to the underside 23. The shaft 21 can also be described as an axle 21, since it extends centrally through the disc. The axle 21 is preferably arranged with respect to the sheet of film 10 so that it is outside the same. The ability to pivot or rotate is shown by the arrow D in FIG. 1. At this point, it should be noted that the pivoting movement in the same transport direction T can be carried out both in the clockwise direction and in the anticlockwise direction. A pivoting movement is understood to mean a rotational movement of an element about a pivot point, the element carrying out parts of an entire revolution or one revolution per cycle. Alternatively, the feed plate 20 or the holding device 24 can also be pivoted into the sheet of film 10 in a first direction, for example in the clockwise direction, and out of the sheet of film 10 again in a second direction which is opposite to the first direction, here therefore in the anticlockwise direction. As mentioned herein, the feed plate 20 can be pivoted wholly or only partly out of the sheet of film 10, depending on the configuration.

This means, in other words and expressed in a general form, that the closure element is moved by means of a pivoting movement from a first position which, seen from above, lies outside the sheet of film 10, into a second position, the second position lying inside or in the region of the sheet of film 10. In this case, the pivoting movement runs in a plane which extends parallel to the surface of the sheet of film 10, that is to say parallel to the upper side 16 of the sheet of film. Apart from the advantages with respect to speed and easier adjustability, the pivoting movement also has the advantage that the closure elements can be arranged in a simple way at an angle to the transport direction T and thus also to the bag being produced, if this is desired.

In alternative embodiments, it is conceivable, for example, for the feed plate 20 to be formed as a segment of a disc, so that a part of the feed plate 20 is always located in the sheet of film.

In the present embodiment, the at least one holding device 24 is let into the feed plate 20 via the upper side 22. In this case, the upper side of the holding device 24 is preferably flat or level with the upper side 22 of the feed plate 20. Alternatively, the holding device 24 can also be let into the feed plate 20, so that when the closure element 11 is joined to the holding device 24, this is level with the upper side 22 of the feed plate 20.

A plurality of holding devices 24 are preferably provided. In the present embodiment, four holding devices 24 are provided. Alternatively, two, three, five, six or more holding devices 24 can be provided. However, the number is of secondary importance, more important is the uniform distribution of the holding devices 24 on the feed plate 20. A uniform distribution is understood to mean that the angle between two adjacent holding devices 24 is always the same. It is also possible to state that a plurality of incremental regions are arranged on the feed plate 20, in each case a holding device 24 being arranged in each of these incremental regions. In this case, the feed plate 20 is pivoted by one increment in each case per cycle, as described below. In the embodiment shown in FIG. 1, four increments are provided, an increment extending over 90°.

The holding device 24 is shown schematically in FIG. 3a. The holding device 24 comprises at least two vacuum nozzles 25 arranged at a distance from one another. As soon as a closure element 11, which is shown dashed in FIG. 3a, is laid on the holding device, the closure element 11 is held on the upper side 22 and on the holding device 24 by the vacuum which is provided by the vacuum nozzles 25. In support, additionally a region 26 of the holding device 24, on which region 26 the closure element 11 rests, can be equipped with an elastomer. The provision of such a region 26 has the advantage that an increased frictional force between the closure element 11 and the holding device 24 can be provided. The elastomer is preferably formed as a silicone mat. The region 26 is preferably larger in plan view than the closure element 11. The region 26 can also be assembled from a plurality of subregions. For example, it is conceivable that such a subregion is in each case arranged around a single vacuum nozzle.

Alternatively, the vacuum nozzle can also be formed as an elongated channel which extends in the direction of the holding device 24. Such an embodiment is shown in FIG. 3b. The region 26 preferably extends around the at least one vacuum nozzle, so that the functional element can rest both on the vacuum nozzle and on the region 26. In addition, during the joining operation described herein, the region 26 can also perform the damping of the joining unit 3. Accordingly, the region 26 is preferably formed in such a way that the joining point between functional element 11 and sheet of film 10 comes to lie on the region 26.

In an additional embodiment, it is additionally conceivable for the vacuum nozzle(s) 25 to be arranged at a lower level than the region 26. In this case, the closure element or functional element rests only on the region 26 but not on the vacuum nozzle(s) 25.

In summary, it is possible to state that the region 26 can function as a seal between the functional element 11 and the vacuum nozzles, as a damper between the holding device 24 and the joining unit 3 and also as a friction-increasing element between functional element 11 and holding device 24.

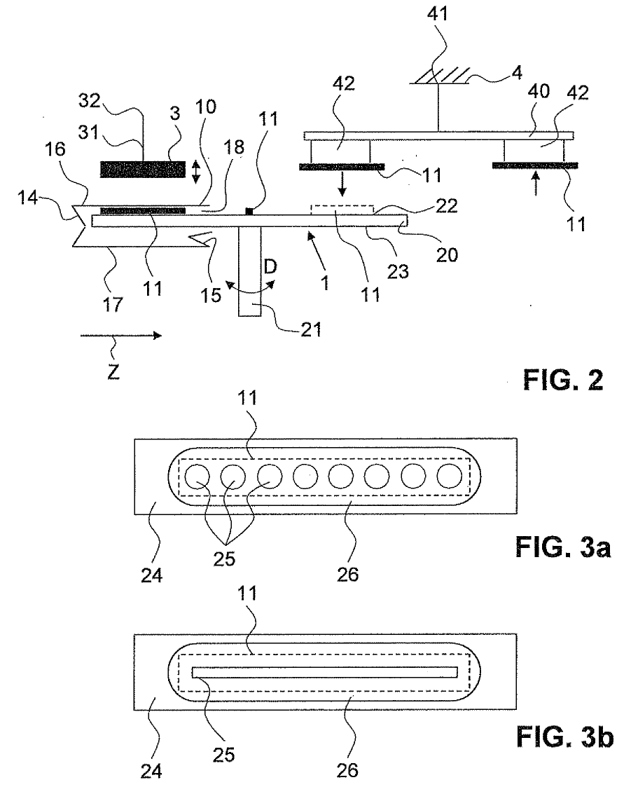

In FIG. 2, a view of the apparatus in the direction of the transport direction T is shown. In this case, it is possible to see that the sheet of film 10 has already been pre-folded. In the present embodiment, the sheet of film 10 comprises a left-hand v-shaped side fold 14 and a right-hand side fold 15. The left-hand side fold 14 is joined to the upper side 16 of the sheet of film and the underside 17 of the sheet of film, while the right-hand side fold 15 is joined either to the underside 17 of the sheet of film or the upper side 16 of the sheet of film. As a result, between side fold 15 and upper side 16 of the sheet of film and underside 17 of the sheet of film there is formed an interspace 18, through which the feed plate 20 and the holding devices 24, on which the closure element 11 is arranged, can project into the folded sheet of film 10.

As can be seen in FIG. 2, the closure element 11 here is joined to the sheet of film 10 on the surface opposite the upper side 16 of the film. This means that the closure element 11 is arranged between the underside 17 of the sheet of film and the upper side 16 of the sheet of film, that is to say in the interior of the bag being produced.

It is a particular advantage if the closure element 11 in the case of an already previously folded sheet of film 10 can be fitted in the interior of the same, since the folding of a sheet of film after the fitting of a closure element is problematic and not reliable with regard to accuracy and efficiency. In particular, it should be pointed out here that this type of fitting can be achieved by the provision of the feed plate 20 projecting into the sheet of film 10 and the holding elements 24 projecting into the sheet of film 10 and their pivoting movement.

The feed plate 20 and the sheet of film 10 are positioned in relation to each other in a direction Z, which is perpendicular to the transport direction T and to the axle 21, in such a way that the holding device 24 or the closure element 11 comes to lie in the desired position relative to the sheet of film 10. The desired position preferably lies in the centre of the upper side 16 of the sheet of film with respect to the direction Z.

The joining unit 3 is arranged physically in such a way that this comes to lie over the position at which the closure element 11 is to be joined to the sheet of film 10. The joining unit 3 is preferably a welding device, which produces a welded connection between the surface directed towards the interior of the sheet of film 10 and the closure element 11. If the closure element is, for example, self-adhesive, then the joining unit 3 can also be formed as a plunger which presses the sheet of film 10 against the closure element 11. Such a joining unit 3 can be moved against the strip of film 10 via appropriate actuators, such as pneumatic cylinders 31. In this case, the pneumatic cylinder 31 is joined to a stationary element 32. Alternatively, it is also conceivable for the joining unit 3 to be arranged as close as possible to the upper side 16 of the sheet of film, and for the holding device 24 or feed plate 20 to move against the joining unit 3.

In a further embodiment, it is additionally conceivable to arrange the joining unit 3 in an apparatus positioned downstream. In this case, the closure element 11 can firstly alternately be fitted by the feeding apparatus, for example via an adhesive, while the joining unit 3 produces the connection between the sheet of film 10 and the closure element 11 at a later time.

In FIG. 2, an example of a loading unit 4 is also shown. The loading unit 4 comprises a yoke 40 which is rotatably connected to a stationary element 41. Each end of the yoke 40 comprises gripping elements 42 which are able to grip a closure element 11. The gripping elements 42 are connected to the yoke via actuators, such as pneumatic cylinders, so that the gripping element 42 is able to grip the closure element 11 from a box or from a conveyor belt and place it on the holding device 24.

With the aid of FIGS. 1 and 2, the functioning of the apparatus according to the invention will now be explained. The strip of film 10 is moved in the transport direction T, while the feed unit 2 is pivoted in the direction D. The movement of the strip of film 10 and of the feed unit 2 is carried out cyclically and synchronously. This means that, during the operation of joining or fixing the closure element 11 to the strip of film 10, both the strip of film 10 and the feed unit 2 are in the desired position and at a standstill.

Here, the progress of a cycle appears as follows. In a first step, the strip of film 10 and the feed unit 2 are moved in the corresponding direction D and T, respectively. In the process, the holding device 24 is pivoted into the fixing position, so that it is located underneath the sheet of film 10. In FIG. 1, the holding device 24a is in the appropriate position. At the same time as the fixing position is reached by the holding device 24a, the section 12a of the strip of film also reaches the fixing position. As soon as the corresponding fixing positions have been reached, the movement in the direction D and T, respectively, is stopped for a predetermined time. During this time, the joining unit 3 joins the closure element 11 to the strip of film 10. As soon as the joining operation has been completed and the predetermined time has elapsed, the cycle begins again. The sheet of film 10 is pushed forward by a section and the feed unit 2 is pivoted by an increment, therefore by 90° here, so that the section 12b of the bag can be provided with the closure element 11 located in the holding device 24b. The dashed line 19 in the section 12b of the bag symbolizes a place-holder at which the closure element 11 located in the holding device 24b is to be fitted.

Furthermore, during the predetermined time, the holding device 24 which is located in the region of the loading device 4 is loaded with a closure element 11. In FIG. 1, this is shown by the closure element 11 illustrated dashed in the holding device 24c.

In FIG. 1, the state of different loading of the holding devices 24 can additionally be seen. In the holding device bearing the reference symbol 24c, in each case a new closure element 11 is inserted and, after two cycles, is removed again at the position 24a in order that it is joined to the sheet of film 10 there.

If the cycle time remains constant, the speed of the strip of film 10 additionally determines the physical length of a section 12 of a bag in the transport direction T. The higher the speed of the strip of film 10, the longer the section 12 of the bag becomes.

The feed plate 20 is driven by the axle or shaft 21 by means of an electric drive, such as by a servo motor, in such a way that this is able to execute the cyclic movement described above. Furthermore, feed lines to the vacuum nozzles 25 are laid via the shaft 21, so that the corresponding vacuum can be provided.

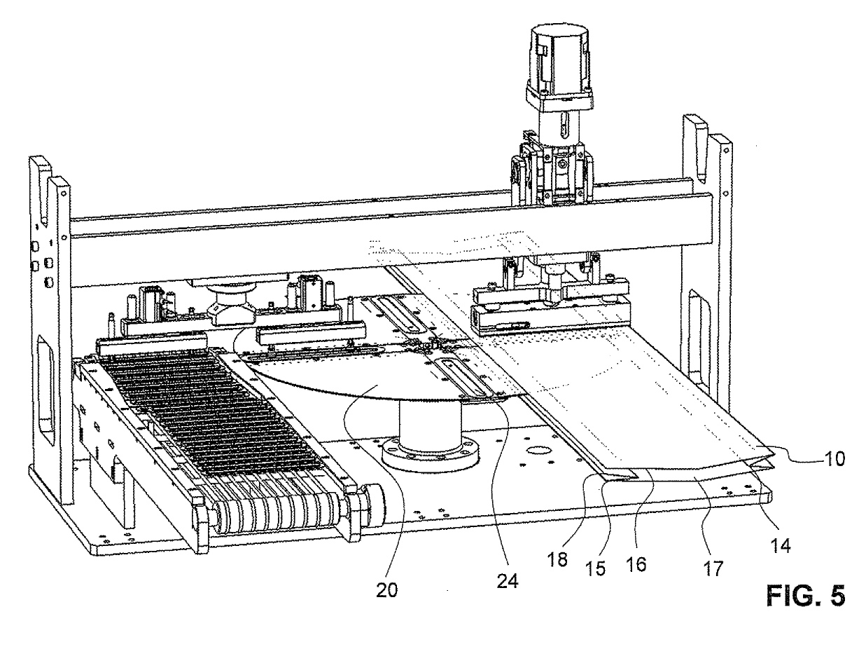

FIGS. 4 and 5 show perspective views of the apparatus according to the invention, the sheet of film being illustrated only schematically by lines 10. The loading apparatus 4 here comprises a conveyor belt 43, with which the closure elements 11 are fed to the gripping element 42. Furthermore, it is also possible to see here that the apparatus according to the invention is arranged on a corresponding machine plinth 5. In this case, the actuators can be placed in this machine plinth 5.

In FIG. 5, an example of a mechanical structure of a feed plate 20 can also be seen. Here, the feed plate 20 comprises four segment elements 27, which can be joined together with four holding devices 24 to form the feed plate 20. In this case, the holding devices 24 are joined to the shaft 21 via fixing means and are used to support the segment elements 27.

Alternatively, and given an appropriate configuration of the holding device 24 as bar-like elements, it is also possible to dispense with the arrangement of the segment element 27. In this case, the bar-like elements are likewise formed with a low thickness, as was described above in connection with the disc. However, it should be noted that the segment elements 27 are advantageous and, for example in the case of non-dimensionally stable films, are to be preferred, since the sheet of film always rests on the feed plate.

In an alternative embodiment that is not shown, it is additionally conceivable for the holding device 24 to be oriented downwards, the vacuum nozzles holding the closure element 11 on the feed plate counter to the force of gravity. In this embodiment, the joining unit 3 then moves from bottom to top. Such an embodiment has the advantage that the closure elements 11 can be provided by means of a conveyor belt, the vacuum nozzles taking the closure element 11 from the conveyor belt.

### LIST OF REFERENCE SYMBOLS

1 Feeding and fixing apparatus
2 Feed unit
3 Joining unit
4 Loading device
5 Machine plinth
10 Sheet of film
11 Functional element or closure element
12 Section of a bag
13 Dividing line
14 Left-hand side fold
15 Right-hand side fold
16 Upper side of sheet of film
17 Underside of sheet of film
18 Interspace
19 Place-holder
20 Feed plate
21 Axle
22 Upper side
23 Underside
24 Holding device
25 Vacuum nozzles
26 Elastomer region
27 Segment elements
31 Actuator
32 Stationary element
40 Yoke
41 Stationary element
42 Gripping element
43 Conveyor belt
T Transport direction
D Direction of rotation

1-14. (canceled)

15. A feeding and fixing apparatus adapted for feeding and fixing a functional element to a sheet of film, the apparatus comprising
a feed unit for holding a functional element, wherein
the feed unit comprises at least one holding device for holding the functional element, the at least one holding device being arranged parallel to the sheet of film and, by means of a pivoting movement, being capable of being positioned in the region of the sheet of film in a plane running parallel to the sheet of film.

16. The apparatus according to claim 15, wherein the feed unit also comprises a feed plate, the at least one holding device being connected to the feed plate, and the surface of the feed plate being parallel to the sheet of film.

17. The apparatus according to claim 15, wherein the feed plate or the holding device can be pivoted about an axle which is substantially perpendicular to the sheet of film.

18. The apparatus according to claim 15, wherein the sheet of film is a folded sheet of film, this being folded in such a way that the feed plate or the at least one holding device can extend or project into the folded sheet of film.

19. The apparatus according to claim 15, wherein at the time at which the functional element is joined to the sheet of film, the holding device is either at right angles to the transport direction or at an angle to the transport direction.

20. The apparatus according to claim 15, wherein the functional element is a closure element, a re-closable closure element, a guarantee element, a viewing window or a reinforcing element.

21. The apparatus according to claim 15, wherein the apparatus further comprises a joining unit for joining the functional element to the sheet of film.

22. The apparatus according to claim 21, wherein the joining unit is a welding device for producing a welded connection between sheet of film and the functional element.

23. The apparatus according to claim 15, wherein the holding device comprises at least one vacuum nozzle which provides a vacuum, so that the functional element is held on the holding device.

24. The apparatus according to claim 18, wherein the holding device further comprises at least one section which provides an increased frictional force between functional element and holding device, the section being made of a plastic chosen from the group of elastomers, such as silicone.

25. The apparatus according to claim 15, wherein at least two holding devices are arranged at a distance from each other, the angle between adjacent holding devices being equal, and it being possible for a holding device to be loaded with a functional element, and it being possible for the functional element from another holding device to be joined to the sheet of film at the same time.

26. The apparatus according to claim 15, the feed unit also comprises a feed plate having a circular shape, the at least one holding device being connected to the feed plate, and the surface of the feed plate being parallel to the sheet of film, wherein the holding device is provided such that it is flush with said surface of the feed plate.

27. A method for feeding and fixing a functional element to a sheet of film, using an apparatus which comprises a feed unit for holding a functional element and a joining unit which produces a connection between the sheet of film and the functional element, wherein, by means of a pivoting movement, the functional element is positioned in the region of the sheet of film in a plane running parallel to the sheet of film and wherein, after the pivoting movement, the functional element is joined to the sheet of film.

28. The method according to claim 27, wherein the apparatus is operated cyclically, during the joining operation the sheet of film and the feed element being at a standstill.
